(19) United States
(12) Patent Application Publication
(10) Pub. No.: US 2018/0128027 A1
(43) Pub. Date: May 10, 2018

(54) Doorstop Assembly

(71) Applicants: Shane Seamans, Fayetteville, NC (US); Jennifer Seamans, Fayetteville, NC (US)

(72) Inventors: Shane Seamans, Fayetteville, NC (US); Jennifer Seamans, Fayetteville, NC (US)

(21) Appl. No.: 15/346,195

(22) Filed: Nov. 8, 2016

(51) Int. Cl. E05C 17/54

(52) U.S. Cl. CPC E05C 17/54

(57) ABSTRACT

A doorstop assembly includes a receiving block having a top side and a bottom side and including a central member, a first arm and a second arm. The central member has an outer side, an inner side, a first lateral edge and a second lateral edge. Each of the first and second arms is attached to the central member and extend away therefrom such that the first and second arms are orientated parallel to each other. The first and second arms are spaced from each other to define a door receiving space that receives an edge of a door. The door receiving space has a width greater than 0.5 inches and a depth greater than 2.0 inches. The receiving block has a weight is greater than 3.0 lbs.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to doorstop devices and more particularly pertains to a new doorstop device for maintaining a door in a selected, open position.

### BRIEF SUMMARY OF THE INVENTION

An embodiment of the disclosure meets the needs presented above by generally comprising a receiving block having a top side and a bottom side and including a central member, a first arm and a second arm. The central member has an outer side, an inner side, a first lateral edge and a second lateral edge. Each of the first and second arms is attached to the central member and extend away therefrom such that the first and second arms are orientated parallel to each other. The first and second arms are spaced from each other to define a door receiving space that receives an edge of a door. The door receiving space has a width greater than 0.5 inches and a depth greater than 2.0 inches. The receiving block has a weight is greater than 3.0 lbs.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use, top perspective view of a doorstop assembly according to an embodiment of the disclosure.

FIG. 2 is a side view of an embodiment of the disclosure.

FIG. 3 is a cross-sectional view of an embodiment of the disclosure taken along line 3-3 of FIG. 2.

FIG. 4 is a front view of an embodiment of the disclosure.

FIG. 5 is a rear view of an embodiment of the disclosure.

FIG. 6 is a bottom perspective view of an embodiment of the disclosure.

### DETAILED DESCRIPTION OF THE INVENTION

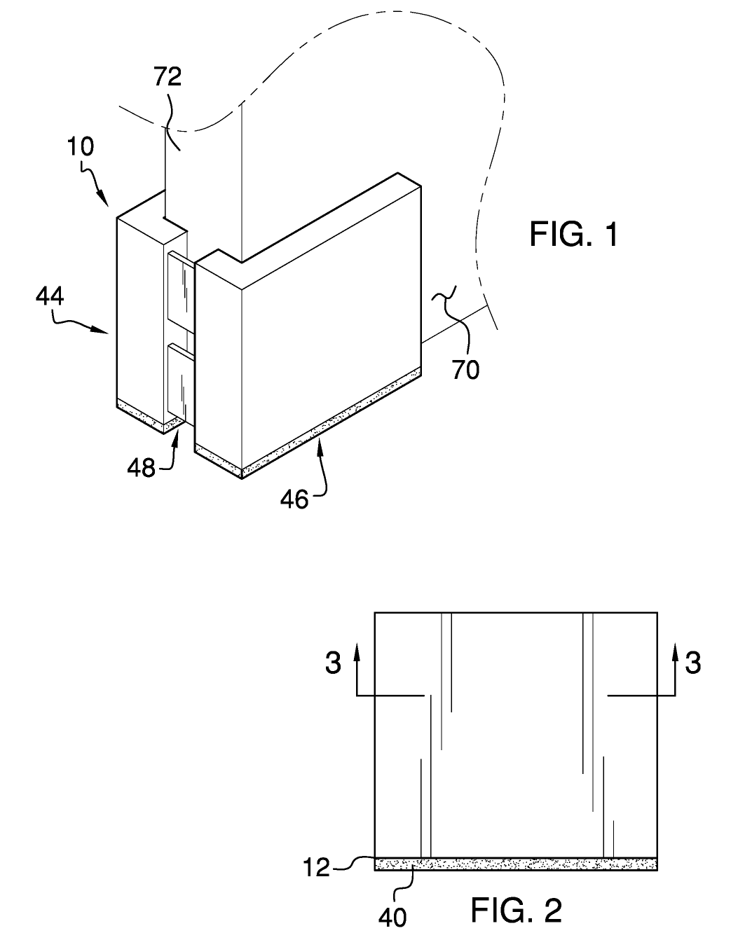

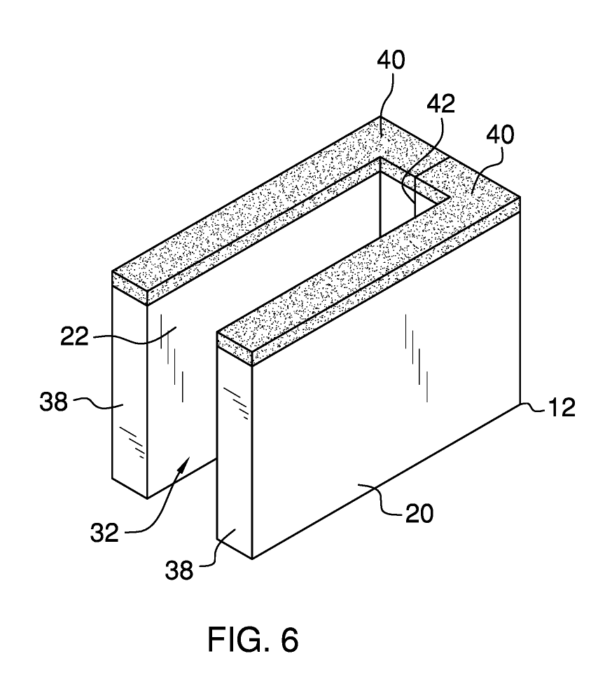

With reference now to the drawings, and in particular to FIGS. 1 through 6 thereof, a new doorstop device embodying the principles and concepts of an embodiment of the disclosure and generally designated by the reference numeral 10 will be described.

As best illustrated in FIGS. 1 through 6, the doorstop assembly 10 generally comprises a receiving block 12 having a top side 14 and a bottom side 16 and including a central member 18, a first arm 20 and a second arm 22. The central member 18 has an outer side 24, an inner side 26, a first lateral edge 28 and a second lateral edge 30. Each of the first 20 and second 22 arms is attached to the central member and extends away therefrom such that the first 20 and second 22 arms are orientated parallel to each other. The first 20 and second 22 arms are spaced from each other to define a door 70 receiving space 32 configured for receiving an edge 72 of a door 70. The door receiving space 32 has a width greater than 0.5 inches and a depth greater than 2.0 inches.

The receiving block 12 has a weight is greater than 3.0 lbs and may preferably have a weight being equal to at least 4.0 lbs. The receiving block 12 may be made out of a high density plastic, rubber or metallic material or may include core 34 of high density material. The receiving block 12 may include an outer covering 36 comprising a resiliently compressible material, or a smooth plastic material, to prevent marring of an objects abutted against the assembly 10. The receiving block 12 may have a height between 4.0 inches and 6.0 inches and a length from the outer side 24 to terminal ends 38 of the first 20 and second 22 arms between 4.0 inches and 6.0 inches. A non-slip material 40 may be attached to the bottom side 16 of the receiving block 12 to enhance the grip being the receiving block 12 a floor surface. The non-slip material 40 may comprise a elastomeric material.

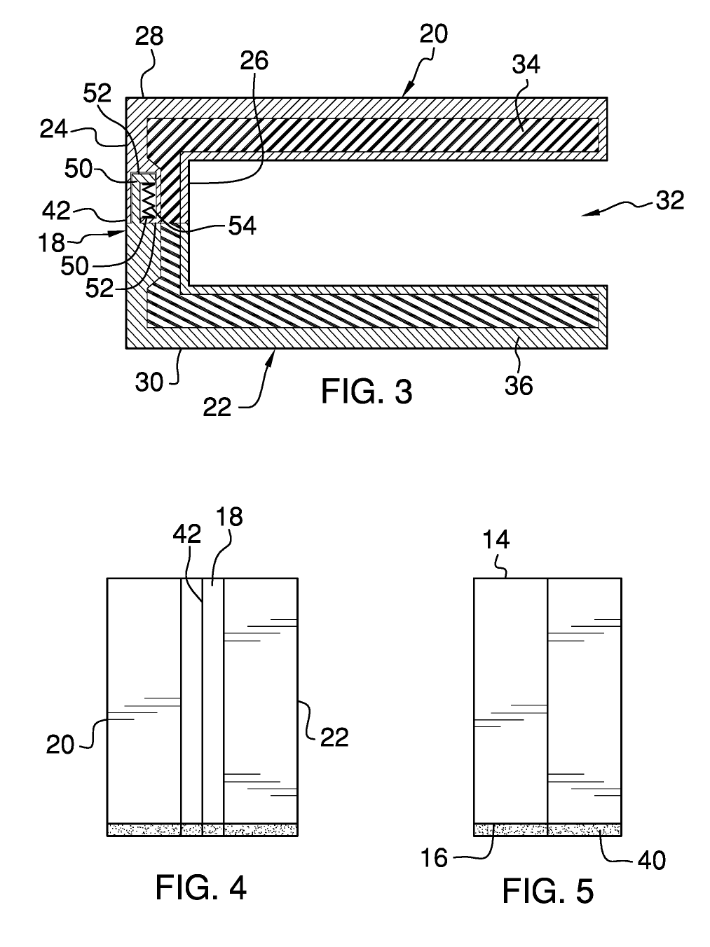

The central member 18 has a break 42 therein to define a first section 44 and a second section 46, wherein the first section 44 includes the first arm 20 and the second section 46 includes the second arm 22. The first 44 and second 46 sections are movable away from each other to increase the width of the receiving space 32. This allows the assembly 10 to accommodate doors 70 of various widths. A coupler 48 engages the first 44 and second 46 sections and retains the first section 44 in connection with the second section 46. The coupler 48 may include a pair of catches 50, wherein each of the first 44 and second 46 sections has one of the catches 50 attached thereto. The catches 50 extend into wells 52 in the first 44 and second 46 sections. The catches 50 prevent the first 44 and second 46 sections from being completely disengaged with each other. An urging member 54 engages the coupler 48 and pulls the first section 44 and the second section 46 toward each other. The urging member 54 may comprise a spring forcing the catches 50 apart and into their respective wells 52 as shown in FIG. 3.

In use, the assembly 10 is slid onto a door adjacent to a bottom edge of the door 70. The assembly 10 provides a weight that cannot be easily moved by the door 70 and thereby retains the door 70 in a position selected by the user of the assembly 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door stop assembly configured to releasably engage and inhibit movement of a door, said door stop assembly comprising:
a receiving block having a top side and a bottom side and including a central member, a first arm and a second arm, said central member having an outer side, an inner side, a first lateral edge and a second lateral edge, each of said first and second arms being attached to said central member and extending away therefrom such that said first and second arms are orientated parallel to each other, said first and second arms being spaced from each other to define a door receiving space configured for receiving an edge of a door, said door receiving space having a width greater than 0.5 inches and a depth greater than 2.0 inches; and
said receiving block having a weight being greater than 3.0 lbs.

2. The door stop assembly according to claim 1, wherein said central member has a break therein to define a first section and a second section, said first and second sections being movable away from each other to increase said width of said receiving space, a coupler engaging said first and second sections and retaining said first section in connection with said second section.

3. The door stop assembly according to claim 2, further including an urging member engaging said coupler, said urging member pulling said first section and said second sections toward each other.

4. The door stop assembly according to claim 1, further including a non-slip material being attached to said bottom side of said receiving block.

5. The door stop assembly according to claim 1, wherein said receiving block has a height being between 4.0 inches and 6.0 inches, said receiving block having a length from said outer side to terminal ends of said first and second arm being between 4.0 inches and 6.0 inches.

6. A door stop assembly configured to releasably engage and inhibit movement of a door, said door stop assembly comprising:
a receiving block having a top side and a bottom side and including a central member, a first arm and a second arm, said central member having an outer side, an inner side, a first lateral edge and a second lateral edge, each of said first and second arms being attached to said central member and extending away therefrom such that said first and second arms are orientated parallel to each other, said first and second arms being spaced from each other to define a door receiving space configured for receiving an edge of a door, said door receiving space having a width greater than 0.5 inches and a depth greater than 2.0 inches;
said receiving block having a weight being greater than 3.0 lbs;
said central member having a break therein to define a first section and a second section, said first and second sections being movable away from each other to increase said width of said receiving space, a coupler engaging said first and second sections and retaining said first section in connection with said second section;
an urging member engaging said coupler, said urging member pulling said first section and said second sections toward each other;
a non-slip material being attached to said bottom side of said receiving block;
said receiving block having a height being between 4.0 inches and 6.0 inches; and
said receiving block having a length from said outer side to terminal ends of said first and second arm being between 4.0 inches and 6.0 inches.
